(19) United States
(12) Patent Application Publication
(10) Pub. No.: US 2006/0293980 A1
(43) Pub. Date: Dec. 28, 2006

(54) Weather-based financial index

(75) Inventors: Paul Mark Corby, Malvern, PA (US); Roberto Correa Machado JR., Wilmington, DE (US); Frederic D. Fox, Berwyn, PA (US)

Correspondence Address: STERNE, KESSLER, GOLDSTEIN & FOX PLLC, 1100 NEW YORK AVENUE, N.W., WASHINGTON, DC, 20005, US

(73) Assignee: Planalytics, Inc., Wayne, PA (US)

(21) Appl. No.: 11/159,252

(22) Filed: Jun. 23, 2005

(51) Int. Cl. G06Q 40/00

(52) U.S. Cl. 705/35

(57) ABSTRACT

A weather-based financial index is based at least in part on weather. The index may take into account any of a variety of weather factors, such as temperature, precipitation, humidity, number of sunny or overcast days in a period of time, number of freeze days in a period of time, etc. Weather factor value(s) are combined with one or more financial components to provide the weather-based financial index. The index may be traded on an exchange, such as the New York Mercantile Exchange (NYMEX). The value of the index may be calculated based on any period, such as daily, weekly, monthly, yearly, etc. Values of the index may provide insight into the direction of a component of the index, a market or industry corresponding to the component, or the index itself.

### BACKGROUND OF THE INVENTION

1. Field of the Invention

The present invention relates generally to financial indexes, and more specifically, to a weather-based financial index.

2. Related Art

Weather provides risk in a financial marketplace. For example, weather may effect the price of a security, an equity, or a commodity. Several techniques have been introduced in an attempt to provide protection against weather-related risks. For example, weather futures may be traded on the Chicago Mercantile Exchange. In another example, over-the-counter derivatives, which are based on the average temperature over a predetermined time with respect to a reference temperature, may be traded as swaps or options. However, such risk management techniques generally do not provide liquidity and have been shunned by the financial markets.

What is needed is a method, system, and/or computer program product that addresses one or more of the aforementioned shortcomings of conventional weather-related risk management techniques.

### SUMMARY OF THE INVENTION

A weather-based financial index is based at least in part on weather. The index may take into account any of a variety of weather factors, such as temperature, precipitation, humidity, number of sunny or overcast days in a period of time, number of freeze days in a period of time, etc. The weather-based financial index includes one or more financial components, each of which may be described as the price per reference unit of a commodity, an equity instrument, or an income instrument. Weather factor value(s) are combined with component(s) to provide the weather-based financial index. Components and/or weather factor values may be combined with respective weighting factors

The weather-based financial index may be traded on an exchange, such as the New York Mercantile Exchange (NYMEX). The value of the index may be calculated based on any period, such as daily, weekly, monthly, yearly, etc. Values of the index may be used to provide insight into the direction of a component of the index, a market or industry corresponding to the component, or the index itself. For example, technical traders may use the index to determine trends or reversals in the corresponding market. Alternatively, the index may be used to hedge against risk that is inherent in the corresponding market.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram of a weather-based index trading system according to an embodiment of the present invention.

FIG. 2 illustrates the weather history database of FIG. 1 according to an example embodiment of the present invention.

FIG. 3 illustrates the component database of FIG. 1 according to an example embodiment of the present invention.

FIG. 4 illustrates an example computer system, in which the present invention may be implemented as programmable code.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to effect such feature, structure, or characteristic in connection with other embodiments whether or not explicitly described.

Although the embodiments of the invention described herein refer specifically, and by way of example, to the energy, retail, and insurance markets, it will be readily apparent to persons skilled in the relevant art(s) that the invention is equally applicable to other markets, including but not limited to grains, metals, currencies, and any of a variety of other commodities, equity instruments, and/or income instruments. It will also be readily apparent to persons skilled in the relevant art(s) that the invention is applicable to any of a variety of exchanges, including but not limited to the Chicago Board of Trade, the Chicago Mercantile Exchange, the Commodity Exchange (COMEX), the New York Coffee Cocoa and Sugar Exchange, the New York Cotton Exchange (NYCE), the New York Futures Exchange (NYFE), the New York Mercantile Exchange (NYMEX), and the New York Stock Exchange (NYSE).

### 1.0 INTRODUCTION

An index provides a measure of change with reference to a base value. In the financial marketplace, an index may be used to measure a change in an economy, a market, or a part thereof, to provide some examples. An index includes one or more financial components. As discussed herein, a financial component is defined as the price per reference unit of a commodity, an equity instrument, or an income instrument. As used herein, the term “commodity” is defined to include without limitation bulk goods and resources capable of being traded, such as electricity. Example reference units include but are not limited to volume, weight, or the instrument itself. Reference units are represented using units of measure, such as gallon, barrel, ounce, ton, etc.

Financial components of an index may be combined in any of a variety of ways to determine the value of the index. For example, the financial components may be averaged together. In another example, the financial components may be given different weights, meaning that the financial components are multiplied by respective factors before being combined to determine the value of the index.

The Standard and Poor's 500 Index (S&P 500) is a widely used index that is calculated based on the market-weighted average of five-hundred U.S. stocks. “Market-weighted” means that the price of each stock is multiplied by a factor that is proportional to the market capitalization of that stock before the prices are combined to determine the value of the index. The price per share of each of the five-hundred stocks is a financial component of the S&P 500.

The Goldman Sachs Commodity Index (GSCI) is another widely used index, including financial components that represent different commodity sectors. The financial components of the GSCI are multiplied by respective weighting factors based on global production of the respective sectors.

Other indexes include but are not limited to the Dow Jones AIG Commodity Index (DJ-AIGCI), the Nasdaq Composite Index, the Russell 2000 Index, and the Value Line Index.

An index may be used for a variety of reasons. The index may be used to provide insight into the direction of a component of the index, a market or industry corresponding to the component, or the index itself. For example, technical traders may use the index to determine trends or reversals in the index, a component of the index, or a corresponding market or industry. Alternatively, the index may be used to hedge against risk that is inherent in the corresponding market or industry.

One risk that is often overlooked in the financial marketplace is weather. For example, none of the indexes discussed above take weather into account, though weather can substantially effect the financial markets. Embodiments of the present invention address the need for a weather-based index.

### 2.0 EXAMPLE WEATHER-BASED INDEX EMBODIMENTS

Weather-based indexes are based at least in part on weather. A weather-based index may take into account any of a variety of weather factors, such as temperature, precipitation (e.g., rain, snow, hail, etc.), humidity, storm activity (e.g., hurricanes, tornadoes, floods, etc.), number of sunny or overcast days in a period of time, number of freeze days in a period of time, etc. A value of a weather factor may represent an average, median, high, low, or change in value, to provide some examples.

A weather-based index is generated by performing an algorithm (e.g., a mathematical algorithm) that incorporates weather-based factor(s). For example, the weather-based financial index may be generated by combining financial component(s) with the weather-based factor(s). In the example weather-based index embodiments described below, financial components are combined to provide a combination of components, and the combination is divided by at least one weather factor value to generate the index. The phrase “divide by” as used herein is defined to include mathematically equivalent operations, such as “multiply by the inverse of”. It will be understood by persons skilled in the relevant art(s) that the operations used to generate the example indexes may be performed in any rational order. For example, each financial component may be divided by a weather factor value before being combined with other components.

The operations described below with reference to the example weather-based index embodiments are provided for illustrative purposes. The example weather-based index embodiments may use operations other than those described below. The example operations set forth below to describe the example indexes need not necessarily be used to generate the indexes. For example, component(s) of an index may be multiplied by a weather factor value, rather than divided by the weather factor value. The phrase “multiplied by” as used herein is defined to include mathematically equivalent operations, such as “divide by the inverse of”. In another example, the value of the weather factor may be exponentially related to the value of the index. In embodiments, the weather-based financial index includes a single financial component. For example, the single financial component and a weather factor value may be combined to provide the weather-based financial index.

2.1 Weather-Based Energy Index Embodiments

A weather-based energy index may include any of a variety of energy components. According to an embodiment of the present invention, the weather-based energy index includes any one or more of the energy commodities that may be traded on the New York Mercantile Exchange (NYMEX), including but not limited to Brent crude oil, coal, electricity, heating oil, propane, light sweet crude oil, natural gas, and unleaded gasoline. The energy component(s) of the weather-based energy index are combined with weather factor value(s) to determine the value of the weather-based energy index. In embodiments, the energy component(s) are combined with respective stocks-to-use ratio(s), supply variable(s), demand variable(s), and/or weighting factor(s). According to embodiments, weather factor values may be combined with respective weighting factors.

In the example weather-based energy index embodiment described below, energy components are multiplied by respective weighting factors. The weighting factors are based on stocks-to-use ratios, supply variables, and/or demand variables of the respective energy components for illustrative purposes. Weighting factors need not necessarily be based on stocks-to-use ratios. In fact, the weather-based energy index need not necessarily include weighting factors.

A stocks-to-use ratio (STU) provides a measure of the relationship between supply and demand for a commodity, for example. The supply and demand may be determined based on any period, including but not limited to a month, year, 2 years, 5 years, decade, etc. The STU may be represented mathematically by the following equation:

$$STU = \frac{A}{B} ; \qquad ( Equation 1 )$$

where A is the ending stock (representing supply) of the commodity for the period, and B is the total use (representing demand) of the commodity during the period.

Referring to Equation 1, the ending stock, A, may be represented by the following equation:
A=C+D−B; (Equation 2)
where C is the beginning stock of the commodity for the period, and D is the total production of the commodity during the period. According to an embodiment, the beginning stock of the commodity represents the carryover from the previous period. For example, the beginning stock may be the amount of the commodity that is in inventory at the beginning of the period. The total production, D, represents the total amount of the commodity that is produced during the period. For example, the total production, D, may include the amount of the commodity that is imported during the period. In another example, the total use, B, may include the amount of the commodity that is exported during the period.

The example weather-based energy index embodiment described herein includes light sweet crude oil (CL), natural gas (NG), heating oil (HO), and gasoline (HU) components. Following is an example calculation of the value of the weather-based energy index, according to an embodiment of the present invention.

The prices for CL, NG, HO, and HU were determined on May 24, 2005 as listed on the NYMEX. The price of CL was $49.00/barrel. The price of NG, using the Henry Hub in Louisiana as the pricing point, was $6.40/MMBtu, where MMBtu represents one million British thermal units (i.e., one million Btu). The price HO, listed on the NYMEX as New York Harbor #2 oil, was $1.37/gallon. The price of HU was $1.40/gallon.

In this example, the prices of the commodities (CL, NG, HO, and HU) are converted to a British thermal unit (Btu) equivalent, based on the burn rate of the respective commodities, for illustrative purposes. The prices of the commodities may be based on any unit of measure. For example, the prices may be converted to a kilowatt-hour equivalent using the relationship 3412 Btu=1 kilowatt-hour. The conversion factor that is used to convert the prices to Btu equivalents is determined by the markets for the respective commodities. On May 24, 2005, the conversion factors, F, for the commodities were as follows: F_{CL}=0.1718, F_{NG}=1.00, F_{HO}=7.21, and F_{HU}=7.99, where the subscripts indicate the commodity to which the conversion factor corresponds. In this example, the conversion factors may be used to convert the prices of the commodities as listed on the NYMEX into price per million Btus (MMBtu).

Applying the conversion factors, the energy components, P, become:

P_{CL}=$49.00/barrel*0.1718 barrels/MMBtu=$8.42/MMBtu,

P_{NG}=$6.40/MMBtu*1.00 MMBtu/MMBtu=$6.40/MMBtu,

P_{HO}=$1.37/gallon*7.21 gallons/MMBtu=$9.88/MMBtu, and

P_{HU}=$1.40/gallon*7.99 gallons MMBtu=$11.19/MMBtu,

where the subscripts indicate the commodity that corresponds to the component.

In this example, the weighting factors, W, corresponding to respective commodities are equal to the STU ratios for the respective commodities. On May 24, 2005, the weighting factors, W, were determined as follows: W_{CL}=STU_{CL}=0.3, W_{NG}=STU_{NG}=0.4, W_{HO}=STU_{HO}=0.2, and W_{HU}=STU_{HU}=0.1.

The value of the weather-based energy index, I, may be represented by the following equation:

$$I = \frac{{P}_{CL} * {W}_{CL} + {P}_{NG} * {W}_{NG} + {P}_{HO} * {W}_{HO} + {P}_{HU} * {W}_{HU}}{T} ; \qquad ( Equation 3 )$$

where T is a weather factor value.

In the example weather-based energy index described herein, the weather factor value, T, is the average temperature for a “basket of cities,” though the scope of the present invention is not limited in this respect. The phrase “basket of cities” is a figurative expression that means a plurality of cities. In this example, the basket of cities includes New York City, Philadelphia, District of Columbia, Montpelier, and Dover. If the average temperature for the basket of cities during the period was 15° C., for example, the value of the weather-based energy index may be calculated as follows:

$$I = \frac{( \$8 .42 * 0.3 ) + ( \$6 .40 * 0.4 ) + ( \$9 .88 * 0.2 ) + ( \$11 .19 * 0.1 )}{15 ° C .} = 0.545 .$$

The average temperature for the basket of cities may be provided in any units of measure, such as ° F., Kelvin, etc. The weather factor value, T, need not necessarily be a temperature.

According to an embodiment, the value of the index is normalized based on a reference value. The reference value may be a prior value of the weather-based energy index or some other value. In this example, the normalized value, I_{N}, of the weather-based energy index based on an arbitrary

$$reference value of 0.0005 is {I}_{N} = \frac{0.545}{0.0005} = 1090.$$

In an embodiment, the weather factor value, T, includes sub-values, S. For example, the weather factor value may include an average temperature sub-value (S₁), a 5-year average temperature sub-value (S₂), a 10-year average temperature sub-value (S₃), and/or a 30-year average temperature sub-value (S₄). Sub-value S₄ may be a 30-year average temperature provided by the National Climatic Data Center (NCDC), for example. The NCDC 30-year average temperature may be referred to as the “Normal”.

In the example above, the sub-values, S₁₋₄, may be combined to provide a simple average or a weighted average. For example, weighting factors may be combined with respective sub-values S₁₋₄. The weighting factors may be based on changes in respective sub-values S₁₋₄, population weighted for National Weather Services Energy Demand Cities.

The calculations described herein with respect to components, weather factor values, sub-values, etc. may be repeated for each period to generate respective weather-based energy index values. The index values may be plotted with respect to time to provide a graphical representation of the weather-based energy index.

According to an embodiment, the weather-based energy index is based on historical data (e.g., temperature, STU, supply variables, demand variables, commodity price, etc.) that begins in 1970 and continues through the present. The index may be retroactive to 1990, for example, and may be normalized to a value, such as 100. Daily weather may be provided on a next day actual basis, settling on the first day of the following month (i.e., when NWS monthly actuals are available), for example. The weather-based energy index may go up or down on a daily and monthly basis for each contract month. These movements may be compounded or netted up to the present day to generate the present day's index value.

2.2 Geographical Weather-Based Index Embodiments

According to an embodiment, the geographic region to which the weather-based index pertains varies with time. For instance, the weather-based index may include first weather data corresponding to a first geographic region during the heating season (October-April) and second weather data corresponding to a second geographic region during the cooling season (May-September). For example, the first geographic region may be a first basket of cities that includes New York, Kansas City, Chicago and Pittsburgh. In another example, the second geographic region may be a second basket of cities that includes New York, Dallas, Houston, New Orleans, and Miami. The example cities mentioned herein are provided for illustrative purposes. The baskets of cities may include any of a variety of cities. In an embodiment, the cities that are included in the first and second baskets of cities are based on those cities utilized in an energy demand analyses performed by the United States Department of Energy. The geographic regions need not necessarily include cities.

In an alternative embodiment, the weather-based index is based on a single geographic region. For example, the weather data used to generate the weather-based index may be based on a particular region. The weather data may be measured in the Rocky Mountain region, the New England region, a basket of cities, areas in which a certain crop may be grown, or areas in which a relatively high amount of a commodity (e.g., heating oil, natural gas, etc.) is consumed, to provide some examples.

2.3 Reference Weather Factor Value Embodiments

A weather-based index value may be calculated based on a reference weather factor value. For example, the reference weather factor value may be subtracted from a measured weather factor value to provide a delta weather factor value. In this example, the delta weather factor value represents the difference between the measured weather factor value and the reference weather factor value. The weather-based index may be generated using the delta weather factor value.

The weather-based index may be generated using an absolute value of the delta weather factor value. For example, a greater difference between the measured weather factor value and the reference weather factor value may have a greater effect on the weather-based index value, regardless whether the measured weather factor value is less than or greater than the reference weather factor value.

In an example embodiment, the value of the weather-based index is inversely proportional to temperature, and the reference weather factor value is a temperature of 65° F. A delta weather factor value may be calculated as the difference between a measured temperature and 65° F. Extreme weather in the heating season may include temperatures much less than 65° F. Extreme weather in the cooling season may include temperatures much greater than 65° F. If the value of the weather-based index is calculated based on the absolute value of the delta weather factor value, then extreme weather leads to a relatively lower weather-based index value, regardless of the season. Extreme weather may be reflected in the weather-based index by a relatively lower index value.

According to another example embodiment, the value of the weather-based index is directly proportional to temperature. In this embodiment, extreme weather may be reflected in the weather-based index by a relatively high index value.

2.4 Other Weather-Based Index Embodiments

A weather-based index may include any type of component(s). According to an embodiment, a weather-based retail index is based on retail stock(s) or economic information. A component of the weather-based retail index may represent a same-store-sales value of an equity, a rate-of-change value of an equity, or a dividends paid per period for an equity, to provide some examples. Same store sales may be based on any period (e.g., weekly, monthly, quarterly, or yearly). A rate of change of an equity indicates the difference between the price of the equity at a first time and the price of the equity at a second time. The rate of change is a measure of the change in price over a period. A component may be based on an economic indicator, including but not limited to the Producer Price Index, Consumer Price Index, unemployment figures, housing starts, etc.

In another embodiment, a weather-based insurance index is based on information that is relevant to the insurance industry. A components of the weather-based insurance index may be based on any of a variety of insurance variables, including but not limited to stock of an insurance company, insurance claim data, insurance-based financial risk exposure (e.g., potential payout), etc. Persons skilled in the art will recognize that the weather-based concepts described herein can be applied to any of a variety of industries and/or markets.

### 3.0 EXAMPLE SYSTEM IMPLEMENTATION

3.1 System Architecture Overview

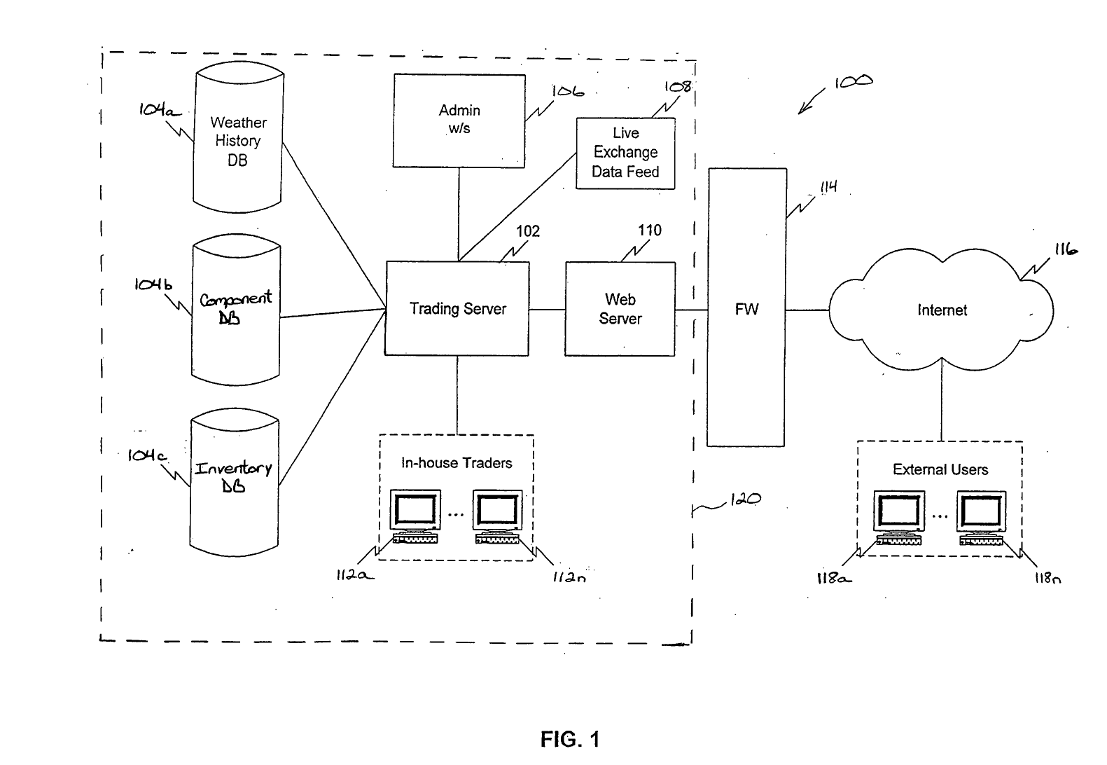

FIG. 1 is a block diagram of a weather-based index trading system 100 according to an embodiment of the present invention. Weather-based index trading system 100 can be used for initializing a weather-based index, for calculating a present value of a weather-based index, and/or for trading a weather-based index. The example architecture shown in FIG. 1 is for illustrative purposes and is not intended to limit the present invention. Other implementations for performing the functions described herein will be apparent to persons skilled in the relevant art(s) based on the teachings contained herein, and the invention encompasses such other implementations.

Referring to FIG. 1, weather-based index trading system 100 includes a communication network 120, which is coupled to one or more external users 118a-118n via a firewall 114 and the Internet. The variable “n” indicates that any number of external users 118a-118n may be connected to communication network 120.

Communication network 120 may be any type of network, such as a local area network (LAN), a wide area network (WAN), etc. Communication network 120 includes a trading server 102, databases 104a-d, an administration workstation 106, a live exchange data feed 108, a web server 110, and one or more terminals 112a-n. Communication network 120 need not necessarily include all elements 102-112 shown in FIG. 1.

Trading server 102 communicates with other elements 104-112 of communication network 120. Trading server 102 may be referred to as the “back-end” or “processing system” of communication network 120. FIG. 1 shows one trading server 102 for illustrative purposes. However, it will be recognized by persons skilled in the relevant art(s) that communication network 120 may include more than one trading server 102.

Databases 104a-d store information associated with financial component(s) and/or weather factor(s) that may be used to generate the weather-based financial index. Databases 104a-d may be stored in memory of trading server 102 or any other server or computer. Databases 104a-d need not necessarily be stored in the same memory. For example, databases 104a-d may be distributed among a plurality of computers/servers.

Administrative workstation 106 may be used by a trading organization, for example, to update, maintain, monitor, and/or record information associated with the weather-based financial index. For instance, the information may be statistics based on component(s) or weather factor(s) that may be used to generate the weather-based financial index.

Live exchange data feed 108 provides information from an exchange (e.g., NYMEX) to trading server 102. The information may include contract prices for components of the weather-based financial index or for the index itself. For example, live exchange data feed may provide real-time quotes of the weather-based financial index or components thereof.

Web server 110 transmits data representing Web pages in response to, for example, Hypertext Transfer Protocol (HTTP) requests from remote browsers. Web server 110 serves as the “front end” of communication network 120. For example, Web server 110 may provide a graphical user interface (GUII) to users of weather-based index trading system 100 in the form of Web pages. Such users may access Web server 110 via any one or more of terminals 112a-n. Terminals 112a-n may be accessible at a facility of a trading organization, for example.

Firewall 114 is an interface between communication network 120 and Internet 116. Firewall 114 determines whether information is allowed to be received by communication network 120 from Internet 116, or vice versa. Firewall 114 utilizes security software to monitor such information. For example, firewall 114 may allow information to be received based on whether firewall 114 recognizes a domain name and/or Internet Protocol (IP) address associated with the information. Firewalls are well known in the relevant art(s).

Internet 116 facilitates communication between communication network 120 and workstations 118a-n, which are external to communication network 120. Workstations 118 may allow traders (e.g., client-users of the trading organization) to remotely access and use weather-based index trading system 100.

Trading system 100 may allow a user at a terminal 112 or a workstation 118, for example, to buy or sell a weather-based financial index contract or to trade a commodity, equity instrument, or income instrument based on the weather-based financial index.

3.2 Weather History Database

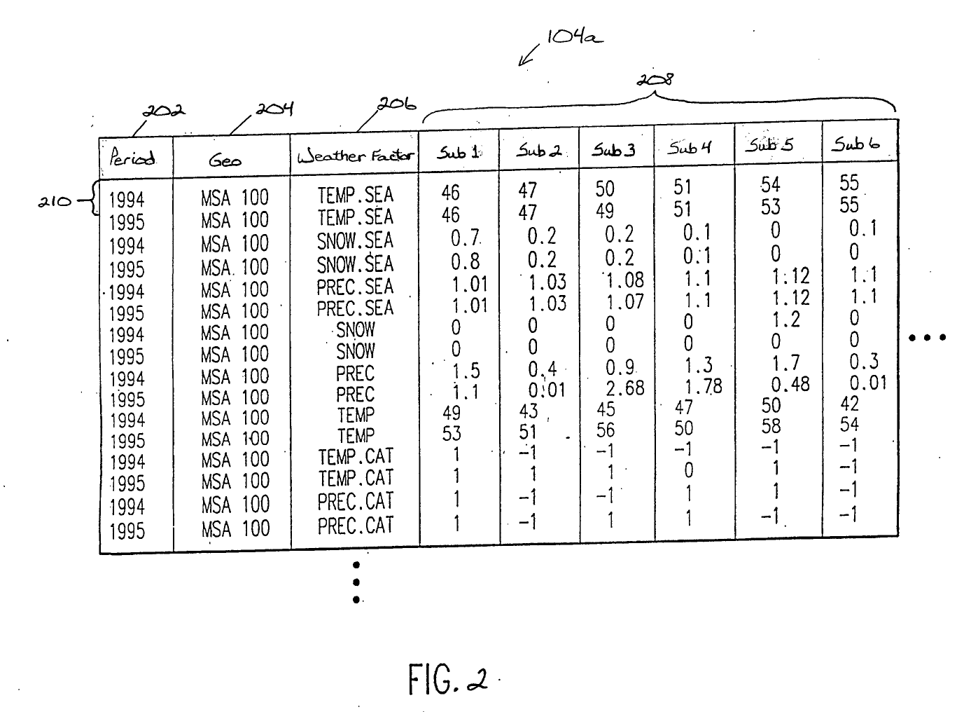

FIG. 2 illustrates weather history database 104a of FIG. 1 according to an example embodiment of the present invention. Embodiments of weather history database 104a are described in commonly-owned U.S. Pat. No. 5,832,456, entitled “System and Method for Weather Adapted, Business Performance Forecasting,” which is incorporated herein by reference in its entirety.

In the example of FIG. 2, weather history database 104a includes period data 202, geographical data 204, weather factor data 206, and value data 208 for each database entry 210. Period data 202 provides the period to which the weather information in database entry 210 pertains. In FIG. 2, period data 202 is annual or yearly data, though the scope of the present invention is not limited in this respect. The period may be any increment of time, such as daily, weekly, bi-weekly, monthly, bimonthly, quarterly, etc.

Geographical data 204 specifies the geographical region(s) or area(s) to which the weather information in database entry 210 pertains. In the example of FIG. 2, “MSA 100” indicates that the weather information in database entry 210 corresponds to a particular metropolitan statistical area (MSA), which is specified as MSA 100. Geographical data 204 is based on a MSA for illustrative purposes and is not intended to limit the types of geographical regions or areas that may be included in weather history database 104a.

Geographical data 204 may be provided for any type of geographic area/region, such a city, a county, a state, and/or a region

Weather factor data 206 indicates the weather factor to which the weather information in database entry 210 pertains. Although example weather factors are discussed above, the example weather factors shown in FIG. 2 will now be described.

In FIG. 2, weather history database 104a includes seasonal (or average), actual, and category (also referred to as “weather pattern”) weather factors. Seasonal weather factors are designated by suffix .SEA, actual weather factors have no suffix, and category weather factors are designated by suffix .CAT.

In the example of FIG. 2, the weather factors include seasonal average mean, maximum, or minimum temperatures (TEMP.SEA), seasonal average snowfall (SNOW.SEA), seasonal average precipitation (PREC.SEA), actual snowfall (SNOW), actual precipitation (PREC), actual temperature (TEMP), actual temperature versus seasonal temperature (TEMP.CAT), actual precipitation versus seasonal precipitation (PREC.CAT), actual temperature versus seasonal last year temperatures, and actual precipitation versus last year precipitation. The example weather factors shown in FIG. 2 are provided for illustrative purposes and are not intended to limit the scope of the present invention. Other weather factors or types thereof may be used.

Value data 208 provides the value of the weather factor specified in weather data 206 for sub-periods (Sub 1-Sub 6). Value data 208 may include one or more sub-periods. Sub-periods (Sub 1-Sub 6) may be any proportion of the period specified in period data 202 of database entry 210. For example, value data 208 may provide the value of the weather factor for the period that is specified by period data 202 of database entry 210. Sub-periods (Sub 1-Sub 6) may be weeks, months, quarters, seasons, days, etc.

As shown in FIG. 2, the value of the category weather factors (e.g., TEMP.CAT and (PREC.CAT) may be −1, 0, or 1. A value of “−1” indicates that the actual value of the weather factor is greater than the seasonal value of the weather factor. A value of “0” indicates that the actual value and the seasonal value are substantially the same. For example, the actual value may equal or substantially correspond to the seasonal value. A value of “−1” indicates that the actual value of the weather factor is below or less than the seasonal value of the weather factor. Values other than those specified above may be used for the category weather factors.

3.3 Component Database

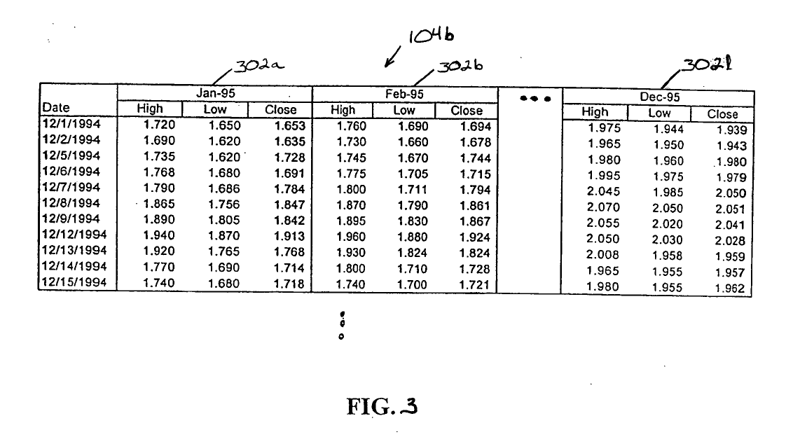

FIG. 3 illustrates component database 104b of FIG. 1 according to an example embodiment of the present invention. Component database 104b includes information corresponding to historical, current, and/or future price(s) of at least one component, based on a respective reference unit. Example reference units include but are not limited to volume, weight, or the instrument itself. Reference units are represented using units of measure, such as gallon, barrel, ounce, ton, etc.

According to an embodiment, historical component information and future component information are stored in separate component databases, though the scope of the present invention is not limited in this respect. For ease of discussion, component database 104b is described below as including historical component information. It will be recognized by persons skilled in the relevant art(s) that component database 104b may include historical, current, or future component information, or any combination thereof.

In FIG. 3, component database 104b includes monthly component information 302a-l for illustrative purposes, though the component information in component database 104b may be based on any period. In FIG. 3, monthly component information 302a-l is based on gas contracts for illustrative purposes. Each monthly component information 302a-l includes daily high, low, and closing prices for gas contracts corresponding to the respective month. Monthly component information 302a-l may be based on any component or the weather-based financial index itself. The daily high, low, and closing prices shown in FIG. 3 may be provided for any period of time. For example, the daily prices may be provided for the previous five years.

As will be appreciated by one skilled in the relevant art(s), component database 104b may include other component and/or financial information. For example, component database 104b may include weighting factor information corresponding to respective components.

3.4 Inventory Database

Inventory database 104c includes historical, current, and/or future inventory information based on at least one component of the weather-based financial index. According to an embodiment, the inventory information includes stocks-to-use (STU) information corresponding to respective component(s). The STU information may include value(s) for beginning stocks, ending stocks, production, imports, demand, exports, and/or stocks-to-use ratio(s), to provide some examples. For example, the STU information or a portion thereof may be obtained from the Department of Energy, Energy Information Administration.

In another embodiment, database 104c includes inventory information provided by at least one agency corresponding to respective component(s) of the weather-based financial index. For example, the inventory information may include historical Energy Information Administration (EIA) inventory information. The EIA conducts technical research and helps create standards for equipment and products for the natural gas industry. The EIA also compiles statistics, which are used as standards for the natural gas industry. One such statistic is the weekly inventory of natural gas, which is measured in cubic feet and is based on each of three regions of the United States: (1) the Producing Region (i.e., the gulf coast); (2) the Consuming East Region (i.e., east of the Rocky Mountains); and (3) the Consuming West Region (i.e., west of the Rocky Mountains). For example, inventory database 104c may include fifty-two weekly measurements for each of the three regions for a historical time period (e.g., the previous five years). Inventory database 104c may include the most currently available EIA inventory information (e.g., information that covers the present week).

The EIA inventory data in inventory database 104c for the three regions may be correlated with weather information in weather history database 104a. For example, the EIA inventory data and the weather information in weather history database 104a may be based on a basket of cities, as discussed above.

### 4.0 USING THE WEATHER-BASED INDEX FOR TRADING

A weather-based index may be used for trading commodities, equity instruments, and/or income instruments, to provide some examples. The index may be used to determine whether to buy or sell a contract, how many contracts to trade, etc. According to an embodiment, the index is used to trade component(s) of the index or the index itself.

The weather-based index has a settlement period that is based on the settlement period of component(s) of the index. For example, if component(s) of the index settle once per month, then the weather-based index settles once per month. The weather-based index can have any settlement period, including but not limited to yearly, quarterly, daily, hourly, or every minute. The index settles after all component(s) of the index settle for the period.

The weather-based index may be traded on an exchange, such as the NYMEX. The instrument used to trade the weather-based index can be the same as an instrument upon which the component(s) of the index are based. For example, if component(s) of the index are prices per unit for futures contracts, then weather-based index may be traded using futures contracts. If the component(s) are prices per unit for options contracts, then the weather-based index may be traded using options contracts.

### 5.0 ENVIRONMENT

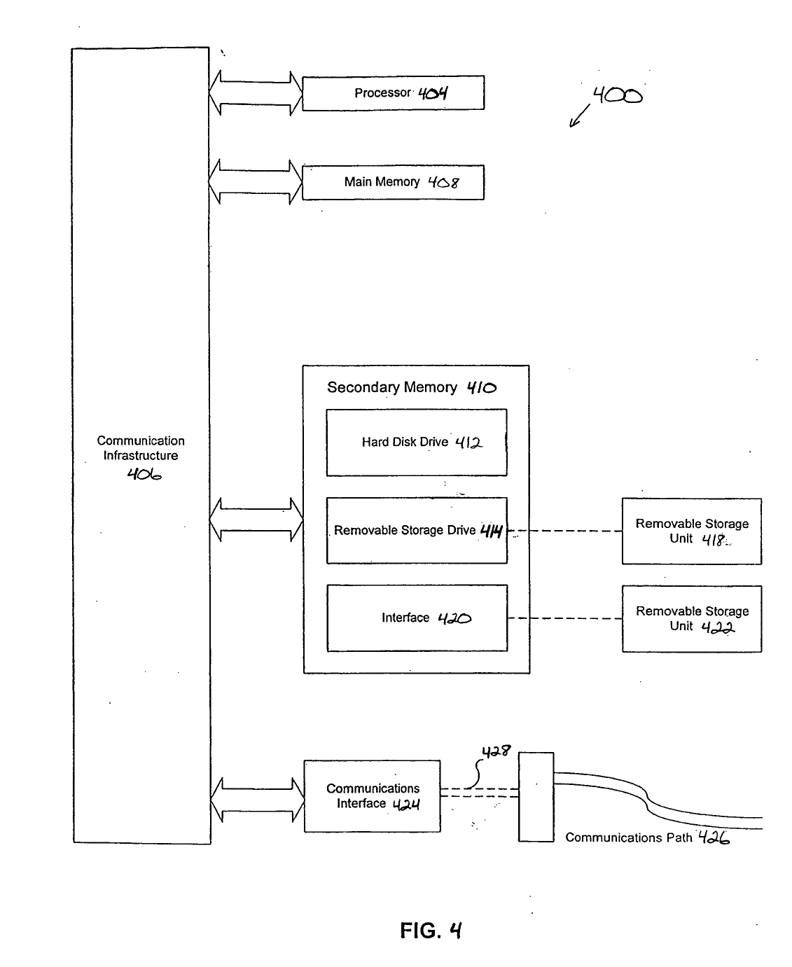

FIG. 4 illustrates an example computer system 400, in which one or more aspects of the present invention may be implemented as programmable code. Various embodiments of the invention are described in terms of the example computer system 400. Any of a variety of aspects of the invention may be implemented as programmable code, including but not limited to generating values of the weather-based financial index, buying or selling a weather-based financial index contract, or trading a commodity, equity instrument, or income instrument based on the weather-based financial index. After reading this description, it will become apparent to a person skilled in the art how to implement the invention using other computer systems and/or computer architectures.

Computer system 400 includes one or more processors, such as processor 404. Processor 404 may be any type of processor, including but not limited to a special purpose or a general purpose digital signal processor. Processor 404 is connected to a communication infrastructure 406 (for example, a bus or network). Various software implementations are described in terms of this exemplary computer system. After reading this description, it will become apparent to a person skilled in the art how to implement the invention using other computer systems and/or computer architectures.

Computer system 400 also includes a main memory 408, preferably random access memory (RAM), and may also include a secondary memory 410. Secondary memory 410 may include, for example, a hard disk drive 412 and/or a removable storage drive 414, representing a floppy disk drive, a magnetic tape drive, an optical disk drive, etc. Removable storage drive 414 reads from and/or writes to a removable storage unit 418 in a well known manner. Removable storage unit 418 represents a floppy disk, magnetic tape, optical disk, etc., which is read by and written to by removable storage drive 414. As will be appreciated, removable storage unit 418 includes a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from removable storage unit 422 to computer system 400.

Computer system 400 may also include a communication interface 424. Communication interface 424 allows software and data to be transferred between computer system 400 and external devices. Examples of communication interface 424 may include a modem, a network interface (such as an Ethernet card), a communication port, a Personal Computer Memory Card International Association (PCMCIA) slot and card, etc. Software and data transferred via communication interface 424 are in the form of signals 428 which may be electronic, electromagnetic, optical, or other signals capable of being received by communication interface 424. These signals 428 are provided to communication interface 424 via a communication path 426. Communication path 426 carries signals 428 and may be implemented using wire or cable, fiber optics, a phone line, a cellular phone link, a radio frequency link, or any other suitable communication channel. For instance, communication path 426 may be implemented using a combination of channels.

In this document, the terms “computer program medium” and “computer usable medium” are used generally to refer to media such as removable storage unit 418, a hard disk installed in hard disk drive 412, and signals 428. These computer program products are means for providing software to computer system 400.

Computer programs (also called computer control logic) are stored in main memory 408 and/or secondary memory 410. Computer programs may also be received via communication interface 424. Such computer programs, when executed, enable computer system 400 to implement the present invention as discussed herein. Accordingly, such computer programs represent controllers of computer system 400. Where the invention is implemented using software, the software may be stored in a computer program product and loaded into computer system 400 using removable storage drive 414, hard disk drive 412, or communication interface 424, to provide some examples.

In alternative embodiments, the invention can be implemented as control logic in hardware, firmware, or software or any combination thereof.

The embodiments above are described by way of example, and are not intended to limit the scope of the invention. Various alternatives may be envisaged which nevertheless fall within the scope of the claims.

### 6.0 CONCLUSION

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above described example embodiments, but should be defined only in accordance with the following claims and their equivalents.

What is claimed is:

1. A method for generating a weather-based financial index, comprising:
combining a plurality of financial components, thereby generating a combination of components; and
dividing the combination of components by a value of a weather factor, thereby generating the weather-based financial index.

2. The method of claim 1, wherein the combining of the financial components includes multiplying the financial components by respective weighting factors.

3. The method of claim 2, wherein the weighting factors include at least one of respective stocks-to-use ratios, supply variables, or demand variables.

4. The method of claim 2, wherein the weighting factors have a common unit of measurement.

5. The method of claim 1, wherein the financial components include a price of at least one of crude oil, natural gas, heating oil, and gasoline.

6. The method of claim 1, wherein the financial components include a value of at least one of an equity instrument, an income instrument, and an insurance variable.

7. The method of claim 1, wherein the weather factor is based on a temperature.

8. The method of claim 1, wherein the weather factor is based on precipitation.

9. The method of claim 1, wherein the weather factor is based on storm activity.

10. The method of claim 1, wherein the weather factor is based on two or more weather variables.

11. The method of claim 1, wherein the financial components represent commodities.

12. The method of claim 1, wherein the financial components represent equity instruments.

13. The method of claim 1, wherein the financial components represent same-store-sales values of respective equities.

14. The method of claim 1, wherein the financial components represent rate-of-change values of respective equities.

15. The method of claim 1, wherein the financial components represent dividends paid per period for respective equities.

16. The method of claim 1, wherein at least one financial component is based on an economic indicator.

17. The method of claim 1, wherein the financial components represent income instruments.

18. A computer program product comprising logic embodied in a medium for causing a computer system to generate a weather-based financial index, the logic including:
a first module that causes the computer system to combine a plurality of financial components, thereby generating a combination of components; and
a second module that causes the computer system to divide the combination of components by a value of a weather factor, thereby generating the weather-based financial index.

19. The article of claim 18, further comprising a third module to multiply the financial components by respective weighting factors.

20. The article of claim 19, wherein the weighting factors include at least one of respective stocks-to-use ratios, supply variables, or demand variables.

21. The article of claim 19, wherein the weighting factors have a common unit of measurement.

22. The article of claim 18, wherein the financial components include a price of at least one of crude oil, natural gas, heating oil, and gasoline.

23. The article of claim 18, wherein the financial components include a value of at least one of an equity instrument, an income instrument, and an insurance variable.

24. The article of claim 18, wherein the weather factor is based on a temperature.

25. The article of claim 18, wherein the weather factor is based on precipitation.

26. The article of claim 18, wherein the weather factor is based on storm activity.

27. The article of claim 18, wherein the weather factor is based on two or more weather variables.

28. The article of claim 18, wherein the financial components represent commodities.

29. The article of claim 18, wherein the financial components represent equity instruments.

30. The article of claim 18, wherein the financial components represent same-store-sales values of respective equities.

31. The article of claim 18, wherein the financial components represent rate-of-change values of respective equities.

32. The article of claim 18, wherein the financial components represent dividends paid per period for respective equities.

33. The article of claim 18, wherein at least one financial component is based on an economic indicator.

34. The article of claim 18, wherein the financial components represent income instruments.

35. A method of generating a weather-based financial index, comprising:
identifying a financial component and a value of a weather factor; and
combining the financial component and the weather factor value, thereby providing the weather-based financial index.

36. The method of claim 35, wherein the combining of the financial component and the weather factor value includes dividing the financial component by the weather factor value.

37. The method of claim 35, further comprising:
multiplying the financial component by at least one of a stocks-to-use ratio, a supply variable, or a demand variable.

38. The method of claim 35, wherein the financial component is based on a price of at least one of crude oil, natural gas, heating oil, and gasoline.

39. The method of claim 35, wherein the financial component is based on a value of at least one of an equity instrument, an income instrument, and an insurance variable.

40. The method of claim 35, wherein the weather factor is based on a temperature.

41. The method of claim 35, wherein the weather factor is based on precipitation.

42. The method of claim 35, wherein the weather factor is based on storm activity.

43. The method of claim 35, wherein the weather factor is based on two or more weather variables.

44. The method of claim 35, wherein the financial component represents a commodity.

45. The method of claim 35, wherein the financial component represents an equity instrument.

46. The method of claim 35, wherein the financial component represents a same-store-sales value of an equity.

47. The method of claim 35, wherein the financial component represents a rate-of-change value of an equity.

48. The method of claim 35, wherein the financial component represents a dividends paid per period for an equity.

49. The method of claim 35, wherein the financial component is based on an economic indicator.

50. The method of claim 35, wherein the financial component represents an income instrument.
